(19) United States
(12) Patent Application Publication
(10) Pub. No.: US 2008/0273630 A1
(43) Pub. Date: Nov. 6, 2008

(54) DECODING SYMBOLS OF A SIGNAL DISTRIBUTED ACCORDING TO FREQUENCY AND TIME DIMENSIONS

(75) Inventors: Philippe Mege, Bourg La Reine (FR); Laurent Martinod, Le Chesnay (FR)

Correspondence Address: LOWE HAUPTMAN HAM & BERNER, LLP, 1700 DIAGONAL ROAD, SUITE 300, ALEXANDRIA, VA, 22314, US

(73) Assignee: Eads Secure Networks, Elancourt (FR)

(21) Appl. No.: 12/110,423

(22) Filed: Apr. 28, 2008

(30) Foreign Application Priority Data
May 4, 2007 (FR) 0754895

(51) Int. Cl. H04L 27/06

(52) U.S. Cl. 375/341

(57) ABSTRACT

A signal of OFDM type received in a radio receiver via a propagation channel includes symbols distributed according to frequency and time. The receiver determines likelihoods of the symbols, decodes the received signal to yield a decoded signal as a function of the likelihoods of the symbols, and estimates an instantaneous noise power of the received signal as a function of a difference between the received signal and a reconstructed noise-free signal derived from the decoded signal. A filtering module determines a bounded distribution of the instantaneous noise power as a function of frequency and/or time, and filters the distribution to yield a filtered noise variance as a function of a frequency and/or time parameter of the propagation channel. A corrector weights the likelihoods of the symbols of the received signal to be decoded as a function of the filtered noise variance.

### BACKGROUND OF THE INVENTION

1—Related Applications

The present application is based on, and claims priority from, French Application Number 0754895, filed May 4, 2007, the disclosure of which is hereby incorporated by reference herein in its entirety.

2—Field of the Invention

The present invention relates to decoding symbols of a radio signal distributed according to frequency and time dimensions. For example, the symbols have undergone orthogonal frequency division multiplexing (OFDM) modulation. The invention relates more particularly to decoding symbols depending on an estimate of the variance of noise mixed with the radio signal.

The invention finds applications in particular in the field of professional mobile radio (PMR) systems.

3—Description of the Prior Art

An OFDM modulated radio signal is distributed over a large number of subcarriers in a frequency band that is wide compared to the spacing between subcarriers. The signal is emitted by a emitter on different subcarriers so that the signal received by a receiver can be reconstituted despite any destructive interference caused by multiple signal propagation paths.

The signal is degraded by noise and interference during its propagation between the emitter and the receiver. Insufficient processing of the noise and interference results in a high decoding error rate. It is known that the receiver equalizes and demodulates the symbols of the received signal and determines the likelihoods of bits corresponding to demodulated symbols in order to decode the information transmitted as a function of the likelihoods so determined.

In the prior art the likelihoods can be corrected as a function of an estimate of the variance of the noise associated with the received signal. An instantaneous noise power can be estimated by means of the difference between the received signal affected by noise and an estimate of the signal as it would be received without noise.

This instantaneous noise power is in particular representative of interference suffered by the received signal and of noise and symbol processing errors, and its amplitude can vary greatly according to the symbols of the received signal. Consequently, this instantaneous power is strongly affected by noise and cannot be used as a good estimate of the variance of the noise.

One solution to this problem is to divide the received signal into predetermined frames of a certain duration, assuming slow variation of the propagation channel. An instantaneous noise power is calculated for each received symbol during a predetermined frame in order to determine for the predetermined frame an estimate of the variance of the noise, which is the mean value of the instantaneous powers. The likelihoods of the symbols are then corrected as a function of this estimate of the variance of the noise, which has a different value for each predetermined frame.

Another solution to this problem is to estimate the local variance of the noise for a given symbol from among several symbols of the received signal distributed in a time-frequency plane representing time intervals and subcarriers of the received signal. This estimated local variance of the noise is a mean value of the instantaneous noise powers estimated for the given symbols and for symbols adjacent to the given symbol in the time-frequency plane. Thus, a local variance of the noise is estimated for each symbol of the received signal. The likelihoods of the symbols are then corrected as a function of this local variance of the noise.

These solutions are based on a mean value of the instantaneous noise power, and the nature of the noise affecting the received signal is immaterial.

### OBJECT OF THE INVENTION

An object of the invention is to improve the estimate of the likelihood of demodulated symbols of a received signal in a digital radio receiver in order in particular to improve symbol decoding performance and to reduce the decoding error rate in spite of the presence of noise and interference in the received signal.

### SUMMARY OF THE INVENTION

To achieve this object, a method in a radio receiver symbols for decoding of a signal received via a propagation channel, the symbols being distributed according to frequency dimension and time dimension. The method includes determining likelihoods of the symbols of the received signal, decoding the received signal into a decoded signal as a function of the likelihoods of the symbols, and estimating an instantaneous noise power of the received signal as a function of a difference between the received signal and a reconstructed noise-free signal derived from the decoded signal. The decoding method is characterized in that it includes:

determining a bounded distribution of the instantaneous noise power as a function of one of the frequency dimension and time dimension,

filtering the bounded distribution of the instantaneous noise power to yield a filtered noise variance as a function of a parameter of the propagation channel expressed in said one dimension, and

weighting the likelihoods of the symbols of the received signal to be decoded as a function of the filtered noise variance.

The parameter of the propagation channel is determined so that filtering the bounded distribution of the instantaneous noise power is restricted to samples of said distribution corresponding to variations of an interference signal present in the propagation channel. This filtering reduces the influence of random noise, which can be subject to fast variations and degrades the decoding of the symbols of the received signal. For example, the bounded distribution of the instantaneous noise power is determined as a function of the frequency dimension, and corresponds to a frequency spectrum of a predetermined number of instantaneous noise powers respectively associated with the symbols received on the same subcarrier of the signal during a frame.

Restricting the variance of the noise to the variations of the interference signal makes the knowledge of each symbol to be decoded more reliable. Weighting the likelihoods of the symbols of the received signal to be decoded as a function of the filtered variance of the noise then makes the likelihoods more reliable and strengthens the veracity of the decisions on the symbols to be decoded into bits.

The signal decoded in the receiver becomes less sensitive to interference caused by signals propagated in channels similar to the propagation channel of the received signal.

For the filtering of the instantaneous noise power to be restricted to the variations of an interference signal, the parameter of the propagation channel depends on physical constraints linked to the propagation channel and to the radio communication network used. In this regard, it is assumed that the interference signal is subject to the same physical constraints as the received signal, i.e. the interference signal is propagated in a propagation channel having properties similar to those of the propagation channel of the received signal. This assertion is valid in particular if the interference signal is a signal of the same network, for example resulting from the re-use of the same frequency channel in another cell of the network, which occurs very frequently, especially in terrestrial cellular radio communication networks. According to the invention, if said one dimension is frequency, the parameter of the propagation channel can be a maximum frequency depending on a maximum speed of relative movement between an emitter and the radio receiver, or if said one dimension is time, the parameter of the propagation channel is a maximum time-delay between time-delays of different propagation paths followed by the received signal caused by multiple reflections of the signal during its transmission in the propagation channel.

However, as will emerge in the remainder of the description, the foregoing two parameters of the propagation channel can be used for frequency filtering and time filtering of the bounded distribution of the instantaneous noise power in order to advantageously increase the reliability of the likelihoods weighted by the filtered variance of the noise. Thus, according to the invention, first and second bounded distributions of the instantaneous noise power are respectively determined as a function of the frequency dimension and the time dimension, i.e. as a function of frequency and time, and the first and second bounded distributions are successively filtered to yield the filtered noise variance as a function of parameters of the propagation channel respectively expressed in the frequency dimension and the time dimension. This filtering operation being a linear operation, it makes no difference if successive filtering according to the frequency dimension and then the time dimension is replaced by successive filtering according to the time dimension and then the frequency dimension.

The invention also relates to a radio receiver for decoding symbols of a signal received via a propagation channel, the symbols being distributed according to frequency dimension and time dimension. The receiver includes means for determining likelihoods of the symbols of the received signal, means for decoding the received signal to yield a signal decoded as a function of the likelihoods of the symbols, and means for estimating an instantaneous noise power of the received signal as a function of a difference between the received signal and a reconstructed noise-free signal derived from the decoded signal. The receiver is characterized in that it comprises:

means for determining a bounded distribution of the instantaneous noise power as a function of one of the frequency dimension and time dimension,

means for filtering the bounded distribution of the instantaneous noise power to yield a filtered noise variance as a function of a parameter of the propagation channel expressed in said one dimension, and

means for weighting the likelihoods of the symbols of the received signal to be decoded as a function of the filtered noise variance.

Finally, the invention relates to a computer arrangement in a radio receiver for decoding symbols of a signal received via a propagation channel, the symbols being distributed according to frequency dimension and time dimension. The computer arrangement is adapted for performing the steps of the method of the invention

### BRIEF DESCRIPTION OF THE DRAWINGS

Other features and advantages of the present invention will become more clearly apparent on reading the following description of embodiments of the invention given by way of nonlimiting example and with reference to the corresponding appended drawings in which:

FIG. 1 is a block schematic of a radio communication receiver according to the invention; and

FIG. 2 shows an algorithm of a method according to the invention for decoding symbols.

### DESCRIPTION OF THE PREFERRED EMBODIMENTS

Generally speaking, the invention described hereinafter relates to a radio communication receiver in a digital cellular radio communication network. The receiver has one or more receive antennas and communicates with an emitter having one or more transmit antennas. For example, the emitter is a mobile terminal and the receiver is a base station, or vice-versa.

In a first example, the radio communication network is a terrestrial, aeronautical or satellite digital cellular radio communication network, a wireless local area network (WLAN), a world wide interoperability microwave access (WIMAX) network, or a professional mobile radio (PMR) network.

In a second example, the radio communication network is an ad hoc wireless local area network with no infrastructure. The emitter and the receiver communicate with each other directly and spontaneously with no intermediary equipment for centralizing communication such as an access point or station or a base station.

In the radio communication network, interference between symbols in a user signal caused by multiple propagation paths, interference between subcarriers caused by Doppler spread that is a consequence of relative movement between the emitter and the receiver, and multiple access interference between signals of several users are generated by propagation in the propagation channel and degrade the quality of the received signal. Such degradation is reduced by estimating the transfer function of the propagation channel using information known in advance to the receiver, such as a pilot sequence emitted by the emitter and distributed over pilot symbols placed in each OFDM signal frame at certain positions in the frequency and time dimensions. Additive noise on reception of the signal degrades this estimate of the transfer function. The received signal sr then comprises a useful signal corresponding to the data transmitted mixed with the additive noise and the interference.

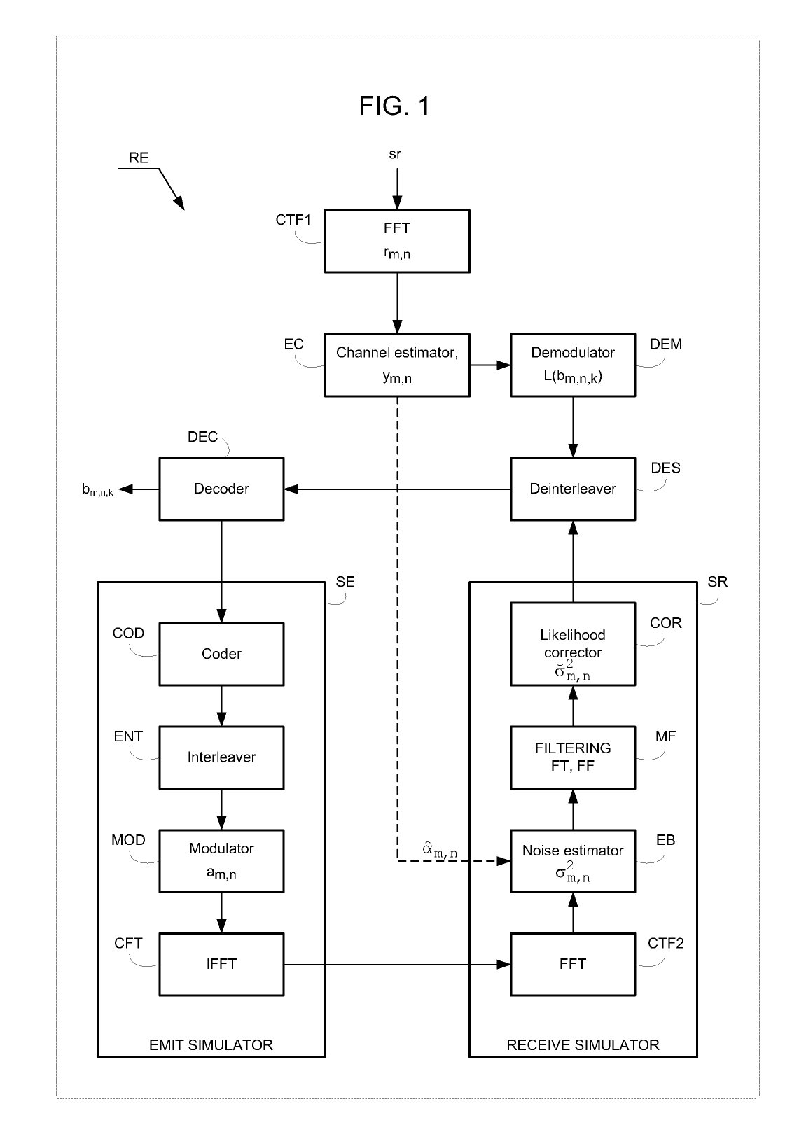

FIG. 1 shows functional means included in a radio communication receiver RE for implementing the method of the invention in a digital radio communication network. The receiver RE comprises in particular a first time-to-frequency converter CTF1, a channel estimator EC, a demodulator DEM, a deinterleaver DES, a decoder DEC, an emit simulator SE and a receive simulator SR.

The emit simulator SE includes a coder COD, an interleaver ENT, a modulator MOD and a frequency-to-time converter CFT.

The receive simulator SR includes a second time-to-frequency converter CTF2, a noise estimator EB, a filtering module MF and a likelihood corrector COR.

The signal sr received by the receiver RE via the propagation channel passes in the receiver through amplifier, baseband signal shaping, sampling and guard interval suppression stages before undergoing fast Fourier transformation (FFT) in the first time-to-frequency converter CTF1 to move the received signal from the time domain to the frequency domain. Each sample in the frequency domain is called a subcarrier. Generally speaking, the first converter CTF1 applies appropriate time filtering to the received signal before the latter undergoes the fast Fourier transform.

The signal sr received by the receiver is emitted by the emitter in the form of successive frames comprising symbols distributed according to a time dimension and a frequency dimension, i.e. with respect to a time axis and a frequency axis. For example, the signal is emitted on M subcarriers in a frame divided into N consecutive symbol time intervals each dedicated to the transmission of M symbols.

The propagation channel between a emit antenna and a receive antenna is modeled by complex coefficients a_{m,n} of the transfer function of the propagation channel associated with respective subcarriers m, where 0≦m≦M−1, for a given time interval n, where 0≦n≦N−1.

A received signal is obtained at the output of the first time-to-frequency converter CTF1 in which each complex symbol r_{m,n} received in the nth time interval on the m^{th} subcarrier is given by the following equation:

r_{m,n}=α_{m,n}×s_{m,n}+b_{m,n},

in which s_{m,n} and b_{m,n} are complex numbers respectively representing a useful signal symbol and the noise received on the m^{th} subcarrier in the n^{th} time interval. The received symbol r_{m,n} is an element of a matrix R of symbols received during a frame:

$$R = [ \begin{matrix}{r}_{0 , 0} & {r}_{0 , 1} & ⋯ & {r}_{0 , N - 1} \\ {r}_{1 , 0} & {r}_{1 , 1} & ⋯ & {r}_{1 , N - 1} \\ ⋯ & ⋯ & {r}_{m , n} & ⋯ \\ {r}_{M - 1 , 0} & {r}_{M - 1 , 1} & ⋯ & {r}_{M - 1 , N - 1}\end{matrix} ] .$$

The received noise b_{m,n} comprises intracellular and/or intercellular interference and additive Gaussian white noise. The received noise b_{m,n} can be written as the sum of the additive Gaussian white noise BB_{m,n} and a symbol u_{m,n} of an interference signal multiplied by a transfer coefficient β_{m,n} of the propagation channel associated with the interference signal. The interference signal is assumed to be of essentially the same kind as the useful signal, for example because of signals emitted in the cellular radio communication network with a frequency band common to that of the received useful signal, and is also emitted on M subcarriers in a frame comprising N symbol time intervals.

The received signal supplied by the first time-to-frequency converter CTF1 is processed by the channel estimator EC, which determines a channel estimate defined by estimated coefficients α_{m,n} of the transfer function of the propagation channel between the emitter and the receiver RE. The channel estimate is determined as a function of pilot symbol sequences contained in the received signal and known to the receiver, for example.

The channel estimator EC also equalizes the received symbols r_{m,n} to yield equalized symbols y_{m,n} as a function of estimated coefficients α_{m,n} of the transfer function of the propagation channel. For example, the equalized symbols y_{m,n} depend on the division of the received symbols r_{m,n} by the estimated coefficients α_{m,n}.

The equalized symbols y_{m,n} are demodulated by the demodulator DEM into demodulated bits, for example by phase quadrature amplitude demodulation (corresponding to a quadrature amplitude modulation (QAM4), also known as quadrature phase-shift keying (QPSK) modulation), mapping a complex symbol +j, +1, −1, −j to a respective pair of consecutive bits (0,0), (0,1), (1,0), (1,1), for example. The equalized symbols y_{m,n} can be stored by the channel estimator EC or the demodulator DEM and supplied by them to the deinterleaver DES and/or the decoder DEC.

The demodulator DEM determines a likelihood L(b_{m,n,k}) of a k^{th} bit b_{m,n,k} contained in an equalized symbol y_{m,n} including K bits, where 0≦k≦K−1. For example, with QAM4 modulation, each symbol is mapped to K=2 bits. In a constellation representing different possible values of dummy symbols z to be emitted, the likelihood of a k^{th} information bit b_{m,n,k} of an equalized symbol y_{m,n} is the difference between the minimum distance between the equalized symbol y_{m,n} and a dummy symbol z the k^{th} bit of which has the value “1” and the minimum distance between the equalized symbol y_{m,n} and a dummy symbol z whose k^{th} bit has the value “0”, according to the following equation:

$$L ( {b}_{m , n , k} ) = {min}_{z / {b}_{k} = 1} {‖ {r}_{m , n} - {\hat{α}}_{m , n} z ‖}^{2} - {min}_{z / {b}_{k} = 0} {‖ {r}_{m , n} - {\hat{α}}_{m , n} z ‖}^{2} . \qquad ( 1 )$$

For formal reasons, and where applicable to prohibit division by zero, an equalized symbol y_{m,n} is multiplied by the respective estimated coefficient \hat{α}_{m,n} and corresponds to the received symbol r_{m,n,} the dummy symbol z is then also multiplied by the estimated coefficient \hat{α}_{m,n}. For example, the likelihood of a bit of a received symbol is determined relative to the 2ⁿ possible symbols of the constellation of QAM type modulation. Moreover, the likelihood L(b_{m,n,k}) is determined assuming a uniform noise power for all the received symbols.

The likelihood L(b_{m,n,k}) has a negative or positive (floating) soft value, compared to a hard value such as the binary value “1” or “0”, to indicate that the demodulator DEM delivers real floating values L(b_{m,n,k}) each having a sign that imposes a subsequent decision as to the state of the corresponding bit b_{m,n,k}, i.e. a decision as to the “hard” value “0” or “1”. The amplitude |L(b_{m,n,k})| represents the reliability of the subsequent decision and is a “flexible” value that represents a trust index of the binary state determined by the sign of L(b_{m,n,k}). The greater the amplitude IL(b_{m,n,k}), the more likely the trust in respect of the binary state corresponding to the sign of the likelihood; at best, the amplitude of the likelihood is a maximum, for example, for each of the four points of the constellation of the QPSK phase modulation. The smaller and closer to 0 the amplitude |L(b_{m,n,k})|, the less certain the binary state corresponding to the sign of the likelihood, i.e. the greater the degree to which the equalized complex symbol y_{m,n} is equidistant from two dummy symbols of the constellation.

The demodulator DEM that has not made any decision to determine hard binary values “0” or “1” supplies in series the numerical likelihood values L(b_{m,n,k}) of the demodulated bits to the deinterleaver DES, those values lying between −1 and +1, for example, according to a predetermined standard. The deinterleaver DES deinterleaves the likelihoods of the demodulated bits using a channel deinterleaving algorithm that is the reciprocal of the channel interleaving algorithm used in an interleaver in the emitter, in order to inhibit the interleaving introduced on emitting the signal.

The decoder DEC decodes the deinterleaved demodulated bits supplied by the deinterleaver DES as a function of the likelihoods L(b_{m,n,k}) previously determined. The decoder DEC makes a hard decision and delivers decoded bits, according to the decoding corresponding to the coding used on emission of the signal, for example convolutional decoding that corrects errors by means of the Viterbi algorithm.

The output of the decoder DEC supplies bits on which a hard decision has been taken to the emit simulator SE in order for the latter to simulate a signal emission system as a function of the bits corresponding to the deinterleaved symbols, by analogy with the emitter.

To this end, the bits outputting from the decoder DEC are applied to the coder COD. The bits outputting from the coder are then interleaved by the interleaver ENT after which they are supplied to the modulator MOD to form estimated symbols a_{m,n} respectively corresponding to the received symbols r_{m,n} that are assumed not to have not suffered any channel deformation. In other words, each estimated symbol a_{m,n} is a better hypothesis of a respective emitted symbol s_{m,n} and corresponds to the bits of a respective received symbol r_{m,n} from the decoder DEC. Each estimated symbol a_{m,n} is a symbol of the reconstructed noise-free signal derived from a respective received symbol of the decoded received signal.

The estimated symbols a_{m,n} are fed to the frequency-to-time converter CFT and undergo in particular an inverse fast Fourier transform (IFFT) to move the signal comprising the estimated symbols a_{m,n} from the frequency domain to the time domain and emit time filtering. The output of the frequency-to-time converter CFT supplies an estimated signal comprising the estimated symbols a_{m,n} to the receive simulator SR.

The second time-to-frequency converter CTF2 of the receive simulator SR applies receive time filtering to the estimated signal suitable for time filtering on emission, followed by a fast Fourier transform FFT to move the estimated signal from the time domain to the frequency domain, in a similar way to the filtering and conversion operations effected in the first converter CTF1. The second converter CTF2 supplies an estimated signal comprising estimated symbols aa_{m,n} to the noise estimator EB.

Alternatively, depending on the type of modulation used, the estimated symbols a_{m,n} at the output of the modulator MOD are not fed to the frequency-to-time converter CFT and are supplied directly to the noise estimator EB; in this case, these symbols are identical to those supplied at the output of the second converter CTF2: aa_{m,n}=a_{m,n}.

The noise estimator EB determines a processing error as a function of a difference between the signal affected by noise initially received and the estimated signal, which is a reconstructed signal with no noise derived from the decoded signal. This error represents a combination in particular of interference, additive Gaussian white noise and channel estimation and decoding errors. To simulate the deformation of the dummy estimated signal transmitted in the same propagation channel as the original received signal, the estimated symbols aa_{m,n} are respectively multiplied by the estimated coefficients \hat{α}_{m,n} of the transfer function of the propagation channel supplied by the channel estimator EC. To be more precise, this error em,n is determined for the m^{th} subcarrier in the n^{th} time interval using the following equation:

e_{m,n}=r_{m,n}−\hat{α}_{m,n}×aa_{m,n}.

The noise estimator EB derives an estimate of the instantaneous noise power σ_{m,n}² associated with the received symbol r_{m,n} as a function of the squared norm of the processing error e_{m,n}:

σ_{m,n}²=∥e_{m,n}∥²=∥r_{m,n}−\hat{α}_{m,n}×aa_{m,n}∥² (2).

According to the invention, the noise estimator EB supplies the instantaneous noise power σ_{m,n}² to the filtering module MF, which applies a time filter FT and/or a frequency filter FF to that instantaneous noise power in order to obtain a filtered noise variance σ_{m,n}².

The filtered noise variance \check{σ}_{m,n}² is then supplied to the likelihood corrector COR in order to weight the likelihoods L(b_{m,n,k}) by the respective filtered noise variance \check{σ}_{m,n}². Applying the time filter FT and frequency filter FF to the instantaneous noise power and correcting the likelihoods L(b_{m,n,k}) as a function of the filtered variance of the noise are described in detail hereinafter in relation to the method used in the receiver RE.

The likelihood corrector COR supplies corrected likelihoods L′ (b_{m,n,k}) to the deinterleaver DES, which deinterleaves these likelihoods before the bits corresponding thereto are decoded by the decoder DEC.

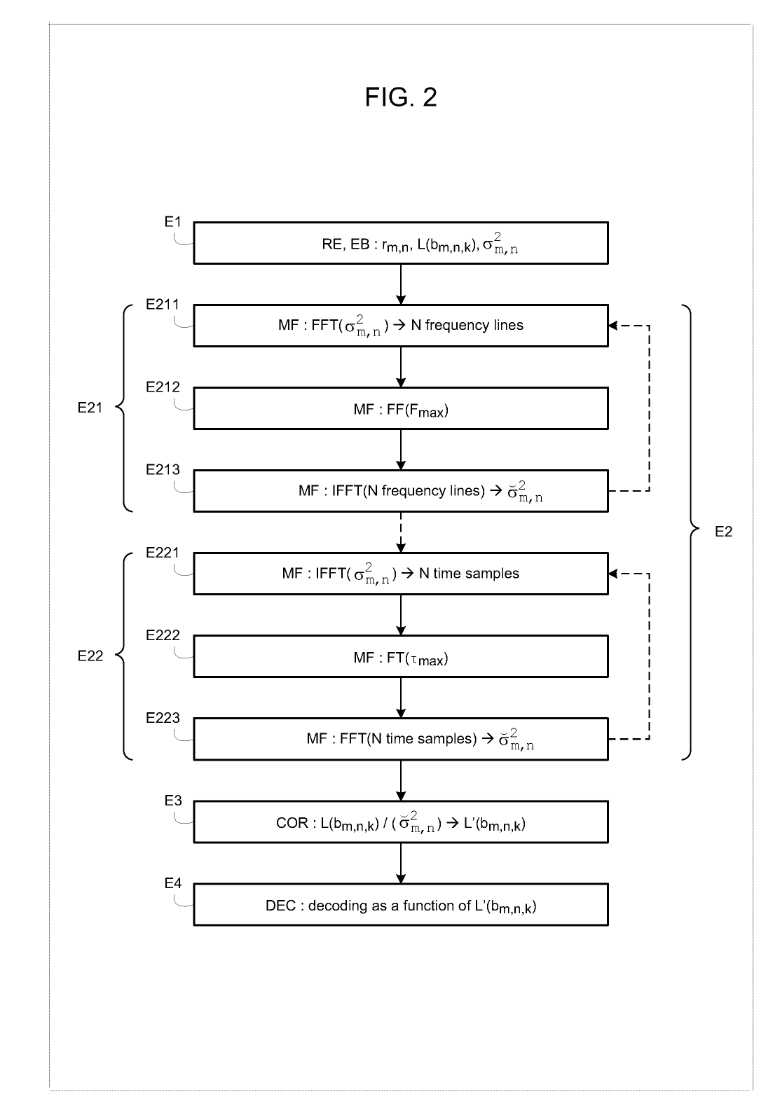

Referring to FIG. 2, the method according to the invention for decoding symbols comprises steps E1 to E4 executed automatically in the receiver RE.

In the step E1, the receiver RE receives a signal transmitted by an emitter in the form of successive frames comprising symbols distributed according to frequency and time dimensions. The signal is emitted on M subcarriers, for example, in a frame divided into N symbol time intervals, for example by orthogonal frequency division multiplexing (OFDM). As explained above, the receiver equalizes symbols of the received signal for each frame, determines likelihoods L(b_{m,n,k)} for the bits of the equalized symbols by assuming a uniform noise power for all the symbols received, and decodes the equalized symbols as a function of the likelihoods that have been determined. By means of the emit simulator SE and the received simulator SR, the receiver produces an estimated signal that is formed as a function of the bits resulting from decoding and is a noise-free reconstructed signal derived from the decoded received signal. The noise estimator EB in the receiver RE then estimates an instantaneous noise power σ_{m,n}² for a received symbol r_{m,n} on the m^{th} subcarrier in the n^{th} time interval as a function of the squared norm of the difference between the initially received signal affected by noise and the signal estimated according to equation (2). The noise estimator EB supplies the instantaneous power of the estimated noise σ_{m,n}² to the filtering module MF.

The instantaneous power of the estimated noise σ_{m,n}² is not obtained by direct subtraction of an equalized symbol signal from the received signal, but as a function of a reconstituted signal with no noise produced from the decoded signal in order to economize on processing as a result of the decisions made during decoding.

In the step E2, the filtering module MF determines at least one filter to be applied to the instantaneous noise power for the symbols received during a frame as a function of at least one of the physical constraints of the propagation channel between the emitter and the receiver. These physical constraints relate to frequency and time, for example.

The filter is characterized by a filter function that adapts to the received signal. The filter function has parameters expressed in at least one of the frequency dimension and time dimension. For example, one parameter depends on a maximum speed of relative movement between an emitter and the receiver and can be updated as a function of the frequency of the carrier of the signal received by the receiver. Limits are then assigned to the filter as a function of those parameters.

Statistically, in particular when interference that stems from a emitted signal other than the useful signal is present on the channel, the estimated instantaneous power σ_{m,n}² of the noise is not uniform in a time-frequency plane representing the M subcarriers and the N time intervals of the signal received during a frame. The noise being a combination of interference, additive Gaussian white noise and channel estimation and decoding errors, the amplitude of the noise variance varies greatly from one symbol to another for all the symbols of the received signal.

The filter determined by the filtering module MF has the function of retaining, or giving preference to, only components of the instantaneous noise power included in areas of the time-frequency plane in which the variance of the noise must have a higher mean amplitude than the variance of the noise in other areas. There exist areas in the time-frequency plane in which interference interferes with the reception of the signal and increases the variance of the noise.

To evaluate the noise variance of a given symbol, symbols belonging to the same time interval or to the same subcarrier as the given symbol, for example, are considered. For example, for an instantaneous power σ_{m,n}² of the noise of a received symbol r_{m,n,} the neighboring symbols considered are also received in the n^{th} time interval or on the m^{th} subcarrier.

The filtering module MF determines a frequency filter FF and a time filter FT in steps E21 and E22, respectively. According to the invention, it is assumed that the interference signal causing intracellular and/or intercellular interference in the received useful signal is subject to the same physical constraints as the received useful signal.

The filtering module MF determines a frequency filter FF in the step E21 comprising sub-steps E211 to E213.

In a sub-step E211, the filtering module MF selects on the time axis the N symbols received successively during N symbol time intervals of a frame on a given one of the M subcarriers. Consequently, the filtering module MF also selects the N instantaneous noise powers respectively associated with the N symbols selected.

The N instantaneous noise powers σ_{m,n}² selected on the time axis undergo fast Fourier transformation (FFT) in order to determine a frequency spectrum of the instantaneous noise power. Thus the filtering module MF determines a bounded distribution of the instantaneous noise power as a function of the frequency dimension, as the set of N instantaneous noise powers σ_{m,n}² selected is limited. The N symbols selected are received in regular succession during N respective time intervals. Consequently, the signal has a sampling frequency Fe that depends on the duration of a time interval and the observation window of the frequency spectrum covers N frequency samples respectively corresponding to the N symbols selected. The spectrum of the instantaneous noise power is centered on a zero frequency corresponding to the frequency Fp of the carrier of the signal, for example, and the frequency samples are distributed over a frequency band the width whereof is equal to the sampling frequency Fe and the limits whereof are equal to −Fe/2 and +Fe/2.

In OFDM modulation, the width of the frequency band of the M subcarriers is very much less at the frequency Fp of the emitted signal carrier which is the mean value of the respective subcarrier frequencies. For example, the frequency of the carrier is 3 GHz and the frequency step between two consecutive subcarriers is 10 kHz.

A frequency-related physical constraint of the propagation channel is a maximum Doppler frequency Fₘₐₓ, for example, which depends on a maximum speed Vₘₐₓ of relative movement between a emitter and the receiver RE and on the frequency of the carrier Fp, the maximum speed of movement Vₘₐₓ being equal to 200 kph, for example. The maximum Doppler frequency Fₘₐₓ has the value Fₘₐₓ=(Vₘₐₓ/c)Fp, where c is the velocity of light.

In a sub-step E212, the filtering module MF determines a frequency filter FF having limits depending on a parameter of the propagation channel expressed in the frequency dimension. This parameter is a limit frequency, for example, which is the maximum Doppler frequency Fₘₐₓ.

In the expression for the instantaneous noise power σ_{m,n}² of equation (2), the squared norm of an estimated coefficient \hat{α}_{m,n} is equivalent to the product of the estimated coefficient by its conjugate. The fast Fourier transform (FFT) applied to the squared norm of the estimated coefficient is then equivalent to the convolution product of the fast Fourier transform FFT of the estimated coefficient by itself. A property of this convolution product is doubling the width of the frequency spectrum of the instantaneous noise power.

Consequently, the limits of the determined frequency filter FF depend on twice the maximum Doppler frequency Fₘₐₓ. For example, the limits of the frequency filter FF coincide with frequencies −2 Fₘₐₓ and +2 Fₘₐₓ in the frequency spectrum of the instantaneous noise power.

Alternatively, the maximum Doppler frequency Fₘₐₓ and consequently the limits of the filter FF depend on the frequency of the given subcarrier.

The filtering module MF filters the frequency samples as a function of the filter FF applied to the frequency spectrum of the instantaneous noise power, i.e. filters the frequency distribution of the instantaneous noise power as a function of the maximum Doppler frequency Fₘₐₓ. For example, the filtering module MF maintains the amplitude of the frequency lines between the limits of the filter FF, i.e. between the frequencies −2 Fₘₐₓ and +2 Fₘₐₓ, and eliminates all other frequency lines. The filter FF behaves as a band-pass filter.

Alternatively, the filter FF can more strongly attenuate the amplitude of the frequency lines beyond the limits of the filter FF than those between the limits of that filter.

In a sub-step E213, the filtering module MF applies the N frequency lines to an inverse fast Fourier transform (IFFT) in order to form N filtered noise variances \check{σ}_{m,n}² corresponding to the N symbols received successively during N time intervals. These N filtered variances of the noise \check{σ}_{m,n}² represent local estimates of the variance of the noise respectively corresponding to the N symbols. A filtered noise variance corresponding to a given symbol from the N symbols selected is therefore not a mean value of the instantaneous noise powers estimated for the N symbols selected, but represents a local estimate of the noise variance of the given symbol as a function of the filtering of the variations of the instantaneous powers of the N symbols selected.

The steps E211 to E213 are executed for each of the M subcarriers of the received signal in the filtering module. After the step E21, the filtering module MF has therefore selected M distinct sets of N symbols, effected M frequency filtering operations, and filtered the N instantaneous noise powers σ_{m,n}² for each of the M subcarriers.

The filtering module MF determines a time filter FT in the step E22 comprising sub-steps E221 to E223 similar to the steps E211 to E213.

In the sub-step E221, the filtering module MF selects on the frequency axis the M symbols received on the M subcarriers simultaneously for a given one of the N time intervals. Consequently, the filtering module MF also selects the M instantaneous noise powers respectively associated with the M symbols selected.

The M instantaneous noise powers σ_{m,n}² selected on the frequency axis undergo inverse fast Fourier transformation (IFFT) in order to determine a time spectrum of the instantaneous noise power. This time spectrum represents the time variations of the instantaneous noise power. The filtering module MF therefore determines a bounded distribution of the instantaneous noise power as a function of the time dimension, since the set of M instantaneous noise powers σ_{m,n}² selected is limited. The M symbols selected are respectively received on regularly spaced subcarriers. Consequently, the time spectrum observation window covers M time samples respectively corresponding to the M symbols selected. For example, the time samples are distributed between a time t=0 and a time t=Te, where the duration Te corresponds to the reciprocal of the difference between the respective frequencies of two consecutive subcarriers.

A time-related physical constraint on the propagation channel is the time dispersion of the propagation channel limited to a maximum time-delay tₘₐₓ from various possible path delays of the received signal, for example. These various path delays are known statistically as a function of the frequency of the carrier of the signal and the environment in which the signal is transmitted and on which the time dispersion of the propagation channel depends. For example, in an urban environment, the time dispersion is typically limited to a maximum time-delay tₘₐₓ of 5 μs and in a mountainous environment the time dispersion is typically limited to a maximum time-delay tₘₐₓ of 15 μs.

In a sub-step E222, the filtering module MF determines a time filter FT having limits depending on a parameter of the propagation channel expressed in the time dimension. This parameter is a limit time, for example, which is the maximum time-delay tₘₐₓ.

As for the frequency filter, applying the inverse fast Fourier transform (IFFT) to the instantaneous noise power σ_{m,n}² doubles the width of the time spectrum of the instantaneous noise power.

Consequently, the limits of the determined time filter FT depend on twice the maximum time-delay tₘₐₓ. For example, the limits of the time filter FT coincide with the times t=0 and t=2 tₘₐₓ.

The filtering module MF filters the time samples as a function of the filter FT applied to the time spectrum of the instantaneous noise power, i.e. filters the time distribution of the instantaneous noise power as a function of the maximum time-delay tₘₐₓ. For example, the filtering module MF maintains the amplitude of the time samples between the limits of the filter FT, i.e. between the times t=0 and t=2 tₘₐₓ, and cancels all other time samples.

Alternatively, the filter FT can attenuate the amplitude of time lines beyond the limits of the filter FT more strongly than those between the limits of that filter.

In a sub-step E223, the filtering module MF applies a fast Fourier transform FFT to the M time samples in order to form M filtered variances of the noise \check{σ}_{m,n}² corresponding to the M symbols received on the M subcarriers simultaneously.

The steps E221 to E223 are executed for each of the N time intervals. Thus after the step E22 the filtering module MF has selected N distinct sets of M symbols, effected N time filtering operations and filtered the M instantaneous noise powers σ_{m,n}² for each of the N time intervals.

Alternatively, only one of the steps E21 and E22 is executed.

Another alternative is for the step E22 to be executed before the step E21. Frequency and time are dual spaces, and the filtering operation is linear. Thus the frequency and time filtering operations are commutative.

If the two filters are used successively by the filtering module MF, the filter used second is applied to the variances of the noise \check{σ}_{m,n}² already filtered by the filter used first. To simplify the notation, the variances of the noise filtered after using one or two filters are interchangeably denoted \check{σ}_{m,n}².

As explained above, the instantaneous noise power according to equation (2) depends on the processing error em,n which is a difference between the signal affected by noise initially received and the noise-free reconstructed signal derived from the decoded signal. Consequently, during the filtering steps E21 and E22, the frequency spectrum FF and the time spectrum FT of the instantaneous noise power contain little information as to the useful signal since the latter has been estimated and subtracted from the received signal. Each spectrum contains information on channel estimation and decoding errors and on additive Gaussian white noise spread over the entire spectrum observation window, and information on the interference signal and on the variations thereof in the propagation channel associated with the interference signal.

The channel estimation and decoding errors are by nature random and are distributed over the whole frame of the useful signal since the symbols of the useful signal are interleaved and multiplexed in time and in frequency before emission of the useful signal. According to the properties of the fast Fourier transform FFT, these localized errors correspond to frequencies distributed in the whole of the frequency spectrum and to time-delays distributed in the whole of the time spectrum, and are therefore at least partly filtered. Similarly, additive Gaussian white noise is inevitable in the received signal and a portion of the white noise can be filtered.

Moreover, the interference signal is considered to be of the same nature as the useful signal. In the expression for the instantaneous noise power, squaring the norm causes the modulation of the interference signal to disappear, or at least attenuates it. If the modulation used is QAM4 modulation, the modulation of the interfering signal disappears. The component relating to the interference signal in the instantaneous noise power is therefore essentially affected by the channel variations to which the interference signal is subjected during propagation on the channel.

The interference signal is further assumed to be subject to the same physical constraints as the received useful signal. The propagation channels respectively associated with the useful signal and the interference signal then have similar properties. Like the useful signal, the interference signal complies in particular with physical constraints such as the maximum Doppler frequency Fₘₐₓ and the maximum time-delay tₘₐₓ. The transfer coefficients β_{m,n} of the propagation channel associated with the interference signal and the transfer coefficients a_{m,n} of the propagation channel associated with the useful signal therefore exhibit similar variations.

The spectrum lines and the samples relating to the transfer coefficients β_{m,n} and therefore to the propagation channel variations associated with the interference signal are between the limits of the filters FF and FT.

The result of the filtering operations effected in the steps E21 and E22 is to eliminate a large part of the additive Gaussian white noise and channel estimation and decoding errors.

In the step E3, the filtering module MF supplies the filtered noise variances \check{σ}_{m,n}² to the likelihood corrector COR. The latter weights the likelihood L(b_{m,n,k}) determined by the demodulator DEM according to equation (1) to yield a weighted likelihood L′ (b_{m,n,k}), for example according to the following equation:

$${L}^{′} ( {b}_{m , n , k} ) = {min}_{z / {b}_{k} = 1} ( \frac{{‖ {r}_{m , n} - {\hat{α}}_{m , n} z ‖}^{2}}{2 {\breve{σ}}_{m , n}^{2}} ) - {min}_{z / {b}_{k} = 0} ( \frac{{‖ {r}_{m , n} - {\hat{α}}_{m , n} z ‖}^{2}}{2 {\breve{σ}}_{m , n}^{2}} )$$

The weighting 2\check{σ}_{m,n}² is the same for the likelihoods of all the K bits of the same symbol of the received signal and is a priori different for one symbol of the received signal to another.

The likelihood of the bits of a symbol is therefore corrected as a function of the filtered noise variance. The reliability of the likelihood is increased if the filtered noise variance associated with the symbol is low, and conversely is decreased if the filtered noise variance associated with the symbol is high.

In the step E4, the likelihood corrector COR supplies the weighted likelihoods L′ (b_{m,n,k}) to the deinterleaver DES, which deinterleaves the weighted likelihoods. The deinterleaver DES then supplies the deinterleaved weighted likelihoods to the decoder DEC, which decodes the bits corresponding thereto as a function of the weighted likelihoods L′ (b_{m,n,k}). The decisions regarding bits with high likelihoods are more reliable, and the bits with low likelihoods can be corrected if appropriate.

Alternatively, the steps E1 to E4 of the method are repeated. After the symbols have been decoded, the receiver again produces an estimated signal that is formed as a function of the bits resulting from decoding and again estimates an instantaneous noise power σ_{m,n}². This is filtered in order to weight the likelihoods of the symbols of the received signal and to decode those symbols as a function of the weighted likelihoods. For example, the number of iterations of the steps E1 to E4 is limited when the estimate of the filtered noise variance converges to within a tolerance.

The method described hereinabove can be generalized to the case where the signals are received at a plurality of antennas of the receiver. In this case a filtered noise variance is calculated for each of the antennas from the estimates of the instantaneous noise powers calculated for each of the antennas.

The invention described here relates to a method and a receiver for decoding symbols of a signal received via a propagation channel, the symbols being distributed according to frequency and time dimensions. In one implementation, the steps of the method of the invention are determined by the instructions of a computer program incorporated in the receiver. The program includes program instructions which carry out the steps of the method according to the invention when said program is executed in the receiver, whose operation is then controlled by the execution of the program.

Consequently, the invention also applies to a computer program, in particular a computer program stored on or in a storage medium readable by a computer and by any data processing device adapted to implement the invention. This program can use any programming language and take the form of source code, object code or an intermediate code between source code and object code, such as a partially compiled form, or any other form desirable for implementing the method according to the invention.

The storage medium can be any entity or device capable of storing the program. For example, the medium can include storage means in which the computer program according to the invention is stored, such as a ROM, for example a CD ROM or a microelectronic circuit ROM, a USB key, or magnetic storage means, for example a diskette (floppy disk) or a hard disk.

What we claim is:

1. A method in a radio receiver for decoding symbols of a signal received via a propagation channel, said symbols being distributed according to frequency dimension and time dimension, said method including:
determining likelihoods of said symbols of the received signal,
decoding said received signal into a decoded signal as a function of said likelihoods of said symbols,
estimating an instantaneous noise power of said received signal as a function of a difference between said received signal and a reconstructed noise-free signal derived from said decoded signal,
determining a bounded distribution of said instantaneous noise power as a function of one of said frequency dimension and time dimension,
filtering the bounded distribution of said instantaneous noise power to yield a filtered noise variance as a function of a parameter of said propagation channel expressed in said one dimension, and
weighting said likelihoods of said symbols of said received signal to be decoded as a function of said filtered noise variance.

2. The method claimed in claim 1, wherein said one dimension is frequency, and said parameter of said propagation channel is a maximum frequency depending on a maximum speed of relative movement between an emitter and said radio receiver.

3. A method as claimed in claim 1, wherein said one dimension is time, and said parameter of the propagation channel is a maximum time-delay between different propagation path time-delays of said received signal.

4. A method as claimed in claim 1, wherein first and second bounded distributions of the instantaneous noise power are respectively determined as a function of said frequency dimension and said time dimension, and said first and second bounded distributions are filtered to yield said filtered noise variance as a function of parameters of said propagation channel respectively expressed in said frequency dimension and said time dimension.

5. A method as claimed in any one of claim 1, wherein said parameters of said propagation channel are a maximum frequency depending on a maximum speed of relative movement between an emitter and said radio receiver, and a maximum time-delay between different propagation path time-delays of said received signal.

6. A radio receiver for decoding symbols of a signal received via a propagation channel, said symbols being distributed according to frequency dimension and time dimension, said radio receiver including:
a demodulator for determining likelihoods of said symbols of the received signal,
a decoder for decoding said received signal into a decoded signal as a function of said likelihoods of said symbols,
an estimator for estimating an instantaneous noise power of said received signal as a function of a difference between said received signal and a reconstructed noise-free signal derived from said decoded signal,
a filtering module for determining a bounded distribution of said instantaneous noise power as a function of one of said frequency dimension and time dimension, said filtering module being adapted to filter the bounded distribution of said instantaneous noise power to yield a filtered noise variance as a function of a parameter of said propagation channel expressed in said one dimension, and
a corrector for weighting said likelihoods of said symbols of said received signal to be decoded as a function of said filtered noise variance.

7. A computer arrangement in a radio receiver symbols for decoding of a signal received via a propagation channel, said symbols being distributed according to frequency dimension and time dimension, said computer arrangement being adapted for performing the following steps:
determining likelihoods of said symbols of the received signal,
decoding said received signal into a decoded signal as a function of said likelihoods of said symbols,
estimating an instantaneous noise power of said received signal as a function of a difference between said received signal and a reconstructed noise-free signal derived from said decoded signal,
determining a bounded distribution of said instantaneous noise power as a function of one of said frequency dimension and time dimension,
filtering the bounded distribution of said instantaneous noise power to yield a filtered noise variance as a function of a parameter of said propagation channel expressed in said one dimension, and
weighting said likelihoods of said symbols of said received signal to be decoded as a function of said filtered noise variance.
